(19) United States
(12) Patent Application Publication
(10) Pub. No.: US 2023/0191483 A1
(43) Pub. Date: Jun. 22, 2023

(54) Fabrication of Open-Porous Titanium Foam Using Space-Holder Process for Use in Load-Bearing Applications

(71) Applicant: CellMobility, Inc., Berkeley, CA (US)

(72) Inventors: Gigap Han, Chungcheongnam-do (KR); Kicheol Hong, Busan (KR); Heeman Choe, Conroe, TX (US)

(21) Appl. No.: 17/996,073

(22) PCT Filed: Apr. 16, 2021
(86) PCT No.: PCT/US2021/027806

§ 371 Date: Oct. 12, 2022

Related U.S. Application Data
(60) Provisional application No. 63/011,944, filed on Apr. 17, 2020.

(51) Int. Cl. B22F 3/16; B22F 3/11

(52) U.S. Cl. CPC B22F 3/162; B22F 3/1134; B22F 2998/10; B22F 2301/205; B22F 2302/45; B22F 2003/247

(57) ABSTRACT

A sodium-chloride-space-holder process with two-step heat treatment is used to create an open-porous metal foam (e.g., titanium foam) with a high porosity of about 70 to 90 percent for use in load-bearing applications. A mechanically reliable titanium foam is manufactured using a space-holder method containing two-step heat treatment where a sodium chloride powder is first sieved for desired pore size range, mixed with titanium powder, and compacted under pressure at high temperature. An additional heat treatment is applied to further strengthen the chemical bonding between the titanium particles after the removal of sodium chloride in water to create pores. This process uses a pneumatic pressing machine in combination with a furnace under an argon gas to simultaneously apply both the pressure and temperature. The resulting titanium foam is chemically well bonded and has enhanced durability for proper used in structural applications.

### Cross-Reference to Related Applications

This application claims the benefit of U.S. application 63/011,944, filed Apr. 17, 2020.

### BACKGROUND OF THE INVENTION

The invention relates to the field of materials and more specifically, to metal foams for use in load-bearing applications.

There is a need for complex shaped metal foam products, microscale large-area thin metal foams with a porosity greater than 80 percent, and techniques for making these foams.

### BRIEF SUMMARY OF THE INVENTION

A sodium-chloride-space-holder process with two-step heat treatment is used to create an open-porous metal foam (e.g., titanium foam) with a high porosity of about 70 to 90 percent for use in load-bearing applications. A mechanically reliable titanium foam is manufactured using a space-holder method containing two-step heat treatment where a sodium chloride powder is first sieved to achieve desired powder size range (i.e., desired pore size range), mixed with titanium powder, and compacted together at high temperature. An additional heat treatment is applied to further strengthen the chemical bonding between the titanium particles after the removal of sodium chloride in water to create pores. This process uses a pneumatic pressing machine in combination with a furnace under an argon gas to simultaneously apply both the pressure and temperature. A process has two heat treatments, a first heat treatment is before sodium chloride powder removal under pressure, and a second heat treatment is after the sodium chloride has been removed. The resulting titanium foam is chemically well bonded and has enhanced durability for proper use in structural applications.

A space-holder process is used to make an open-porous metal foam (e.g., titanium foam) for use in load-bearing applications. A titanium foam can be fabricated using a space-holder method where a sodium chloride powder is to be removed later in water to create pores. Here, a combination of high temperature and pressure is applied together to help titanium particles sintered more effectively (particles chemically bonding together to a higher extent) than the application of only heat or pressure. A process uses a furnace with an argon gas (or other noble gas) flow. An additional heat treatment is essential to further strengthen the open-porous metal foam product for use in load-bearing applications. Therefore, the sintering process has two heat treatments, a first heat treatment is before sodium chloride powder removal, and a second heat treatment is after the sodium chloride has been removed. The resulting titanium foam is chemically well bonded and has enhanced durability for most load-bearing applications.

In an implementation, a titanium foam has a porosity ranging from about 70 percent to about 90 percent, and a pore size distribution in any interval between about 30 microns and about 300 microns. The pore size distribution can range between about 50 microns to about 100 microns. The pore size distribution can range between about 100 microns to about 300 microns.

In various implementations, a structural component is made from a titanium foam, where the titanium foam is ground or machined using a water-jet method, wire-cutting method, or saw cutting method.

A manufacturing process to create the porous titanium foam comprises a sodium-chloride-space-holder method that can include: The sodium chloride space holder powder is sieved to achieve an appropriate range of size, between about 30 microns and about 300 microns by applying a sieving process. The sieved sodium chloride and titanium powders are mixed for about 5 minutes to about 30 minutes in an automatic mixer. The mixture of the sieved sodium chloride and titanium powders is heated under argon gas in a furnace and pressed using a pneumatic presser for about 10 minutes to about 12 hours at between about 200 degrees Celsius and about 800 degrees Celsius under the pressure of about 10 megapascals to about 200 megapascals. The compacted sodium chloride and titanium composite is immersed in water for about 30 minutes to about 24 hours to dissolve away sodium chloride from the titanium foam using sonication or stirring. An additional high-temperature sintering at between about 700 degrees Celsius and about 1200 degrees Celsius is conducted under argon gas for about 0.5 hours to about 10 hours. And, the titanium foam is filled with a crystal bond or polymer resin prior to grinding, cutting, and machining to form into a complex shaped component or part with smooth cut surfaces.

Further, in various implementations, at least one of polymer, carbamide (CO(NH₂)₂, saccharose crystals, urea, or calcium chloride powder is used as a space holder to replace sodium chloride powder.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows schematic diagram of titanium foam processing using a two-step heat-treatment sintering for load-bearing applications.

FIG. 2A shows a photograph of sieves capable of controlling desired sodium chloride particle sizes. FIG. 2B shows a scanning electron micrograph of the resulting sodium chloride particles with a desired size range.

FIG. 3 shows high-temperature pneumatic press machine to prepare sintered titanium-sodium chloride composite.

FIG. 4 shows x-ray diffraction patterns of hot-pressed titanium foam-sodium chloride composite after sintering but before dissolving away the sodium chloride particles in water.

FIG. 5 shows x-ray diffraction patterns of the final pure titanium foam after dissolving away the sodium chloride particles in water.

FIG. 6 shows optical micrograph of polished surface of titanium foam processed via one-step heat-treatment sintering.

FIGS. 7A and 7B show scanning electron micrographs of fracture surface of titanium foam exhibiting loosely bonded titanium particles after a single heat-treatment process.

FIGS. 8A and 8B show optical micrographs of polished surface of titanium foam processed via a two-step heat-treatment sintering process.

FIGS. 9A, 9B, 9C, and 9D show scanning electron micrographs of fracture surfaces of titanium foam (exhibiting tightly bonded titanium particles after a two-step heat-treatment process.

FIGS. 10A and 10B shows scanning electron micrographs of fracture surfaces of titanium foam exhibiting firmly chemically bonded titanium particles after a two-step heat-treatment process.

FIG. 11 shows photograph of a titanium-foam square bar with smooth surfaces, showing excellent machinability for structural component applications.

### DETAILED DESCRIPTION OF THE INVENTION

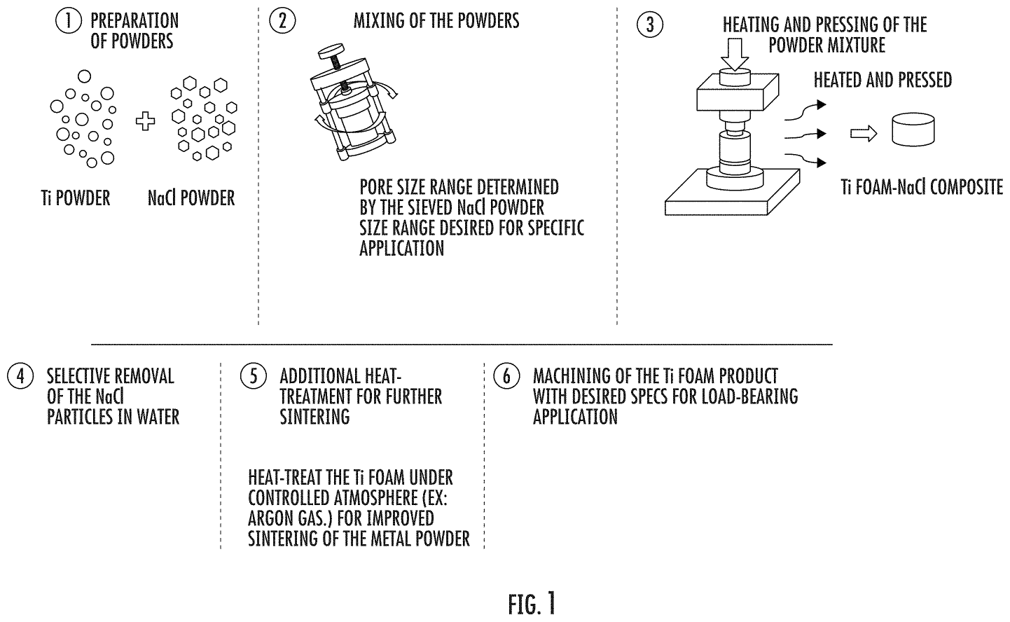

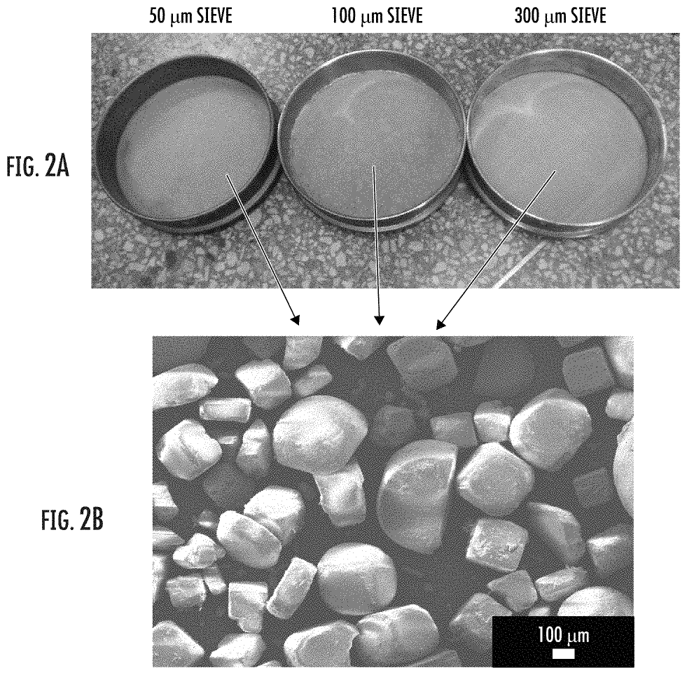

FIG. 1 shows schematic diagram of titanium (Ti) foam processing using a two-step heat-treatment sintering for load-bearing applications. There are various aspects of an implementation of this salt (sodium chloride)-based space-holder method, which includes mixing the sodium chloride (NaCl) and metal powder (e.g., titanium powder) together (steps 1, 2, and 3), eventually removing the space holder, and leaving behind the pore spaces with controlled size and shape (steps 4, 5, and 6); here, it is important that the space holder powder is in the right range of size, preferably between tens of microns and a few hundreds of microns by sieving (FIG. 2).

In the hot pressing of the mixture of prepared sodium chloride and metal powders (step 3), the sodium chloride powder just acts as a pore space holder and can be rinsed and removed at a later stage. After the removal of the salt powder (step 4), an additional high-temperature heat-treatment (step 5) is applied to the metal foam (e.g., FIG. 1) to enhance the strength and ductility of the metal foam for load-bearing applications. In addition, polymer particles, low melting-point metals such as tin, magnesium, or zinc, carbamide (CO(NH₂)₂, saccharose crystals, urea, or calcium chloride (CaCl₂) can also be used as a space holder, since they can be molten or washed away.

1. Referring to FIG. 1, in step 1, the powders are prepared. There is a titanium powder and a sodium chloride powder.

2. In step 2, the powders are mixed. Pore size range is determined by the sieved sodium chloride powder size range desired for specific application.

3. In step 3, the powder mixture is heated and pressed. The result is a titanium form, sodium chloride composite.

4. In a step 4, sodium chloride particles are selectively removed in water.

5. In a step 5, there is an additional treatment for further sintering of titanium particles. In particular, the titanium foam is heat-treated under a controlled atmosphere (e.g., argon gas) for improved sintering of the metal powder.

6. In a step 6, the titanium foam product is machines with the desired specifications for a load-bearing application.

The processing flow in FIG. 1 may have additional steps (not necessarily described in this patent), different steps which replace some of the steps presented, fewer steps or a subset of the steps presented, or steps in a different order than presented, or any combination of these. Further, the steps in other implementations may not be exactly the same as the steps presented and may be modified or altered as appropriate for a particular application or based on the situation.

FIGS. 2A shows a photograph of sieves (e.g., 50 micron, 100 micron, and 300 micron sieves) being capable of controlling and achieving desired sodium chloride particle size range. FIG. 2B shows a scanning electron micrograph of the resulting sodium chloride particles with a desired size range after sieving process. Here, it is important to have a targeted, desired pore size range by applying a controlled sieving process for a specific application (e.g., battery electrode, supercapacitor electrode, structural component, or many others).

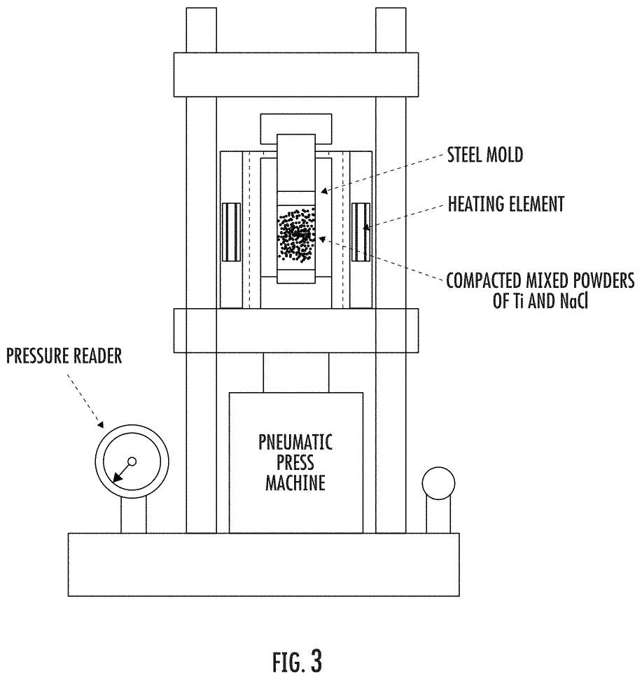

FIG. 3 shows a high-temperature pneumatic press machine to prepare sintered titanium-sodium chloride composite. A furnace containing heating elements encloses the top and bottom pressing molds and the compacted composite of titanium and sodium chloride composite. Although the application of pressure at room temperature may be sufficient in some cases, the application of pressure at high-temperature is desirable for the result of stronger titanium particle bonding during sintering in higher-porosity titanium foam fabrication and thus improved mechanical properties of the resultant titanium foam.

The pneumatic press machine has a steel mold, heating element, and pressure reader. The mixed powders of titanium and sodium chloride are placed in the steel mold of the press. These is a heating element adjacent to the steel mold, which heats up the powder in the mold. The pneumatic press machine presses or exerts pressure on the powder in the mold to compact the powders together.

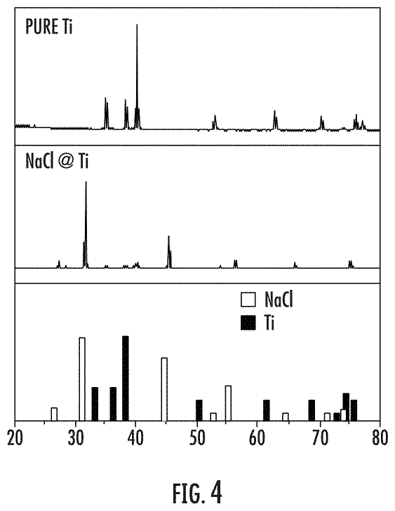

FIG. 4 shows x-ray diffraction patterns of hot-pressed titanium foam-sodium chloride composite after sintering at about 650 degrees Celsius for about 2 hours but before dissolving away the sodium chloride particles in water. It is noted that only titanium and sodium chloride are detected without presence of any undesirable impurities or new phases. The desirable range of applied pressure is between about 10 megapascals and 200 megapascals and the desirable range of applied temperature is between about 200 degrees Celsius and 800 degrees Celsius for an interval of about 10 minutes to about 12 hours under argon gas.

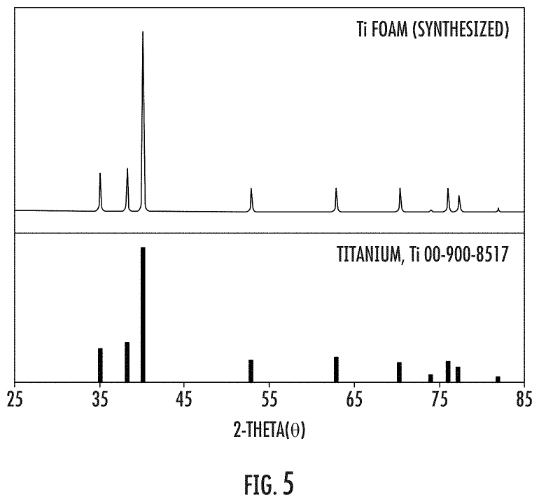

FIG. 5 shows x-ray diffraction patterns of the final pure titanium foam after dissolving away the sodium chloride particles in water to demonstrate the successful processing of titanium foam with no compositional change or impurities being present. The cleansing time in water ranges from about 30 minutes to about 24 hours depending on the size of the product. The use of a stirring or sonication device in water can help expedite the cleansing process.

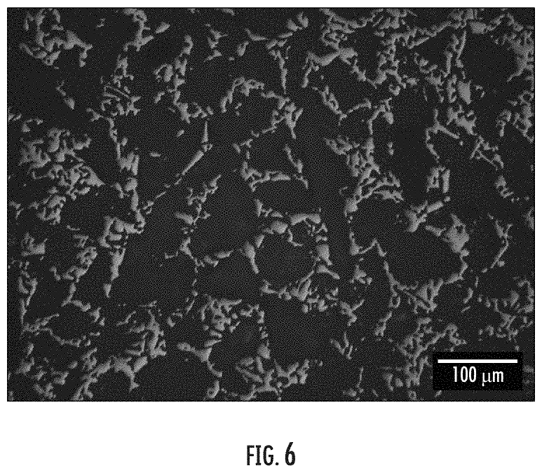

FIG. 6 shows optical micrograph of polished surface of titanium foam processed via one-step heat-treatment sintering. The two-step heat-treatment is desirable; however, a single-step heat treatment may be sufficient for some applications such as energy electrodes, which do not require decent load-bearing capability. On the other hand, achieving higher porosity than about 80 percent is generally difficult to achieve without applying an additional heat treatment.

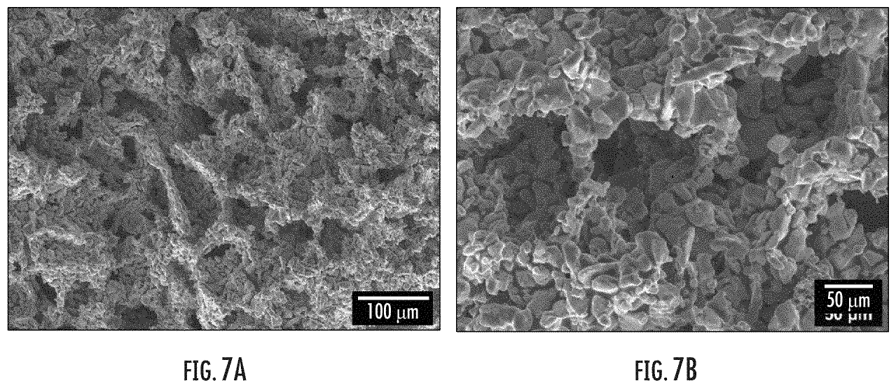

FIGS. 7A and 7B shows scanning electron micrographs of fracture surface of titanium foam (77 percent porosity) exhibiting loosely connected titanium particles after a single heat-treatment process. The scanning electron micrographs in FIG. 7A and 7B are at different magnification levels. This titanium foam may not have sufficient strength and ductility for load-bearing applications. Moreover, this single heat-treatment process is not suitable for the manufacture of titanium foam with more than about 80 percent porosity.

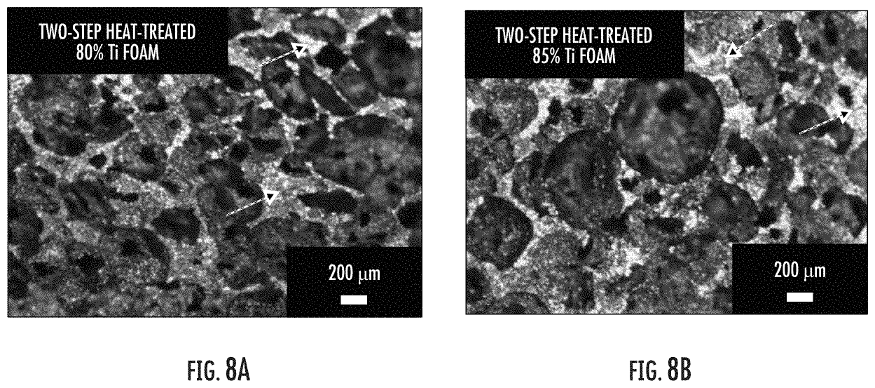

On the other hand, FIGS. 8A and 8B show optical micrographs of polished surface of titanium foam processed via a two-step heat-treatment sintering process. FIG. 8A shows a two-step heat-treated 80 percent titanium foam. FIG. 8B shows a two-step heat-treated 85 percent titanium foam.

Arrows indicate white-colored areas where it is evident that strong chemical bonding of metallic titanium particles took place. Owing to the two-step sintering process, titanium foams with higher porosity (above 80 percent up to 90 percent) can be successfully manufactured.

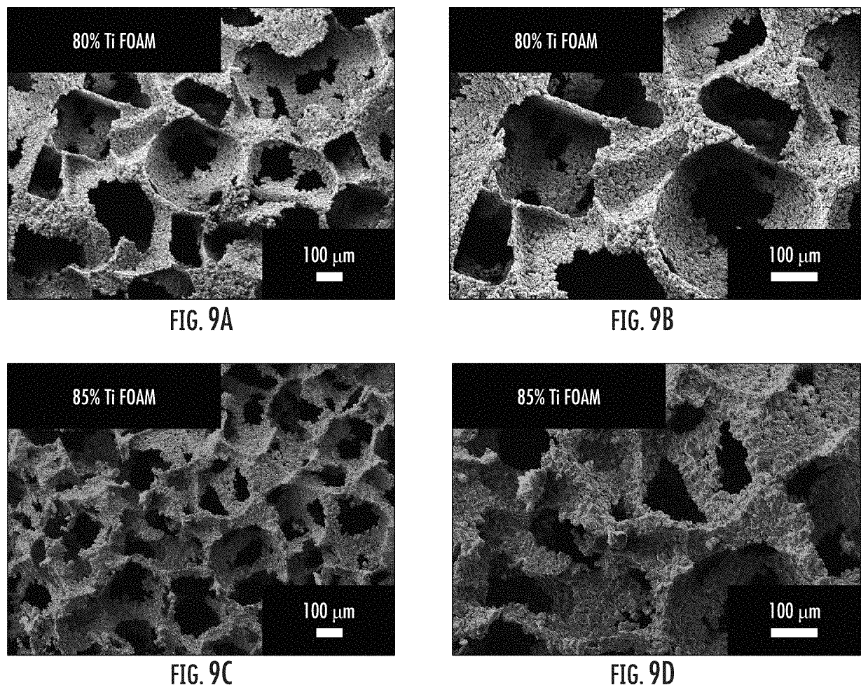

Additionally, FIGS. 9A, 9B, 9C, and 9D show scanning electron micrographs of fracture surfaces of titanium foam (about 80 percent to about 85 percent porosity) exhibiting tightly bonded titanium particles after a two-step heat-treatment process. The applied pressure and temperature were about 100 megapascals and about 650 degrees Celsius, respectively, with an additional heat treatment at about 1000 degrees Celsius following the removal of sodium chloride. These titanium foams are expected to possess sufficient strength and ductility for various load-bearing applications.

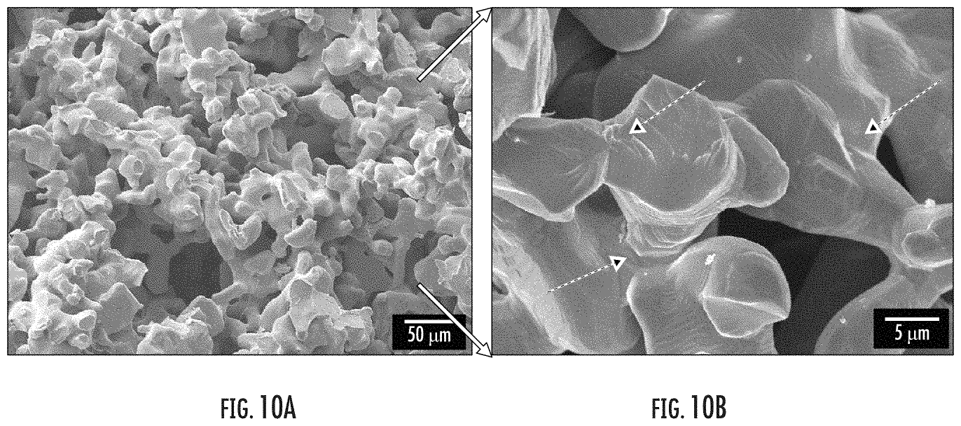

The effect of the additional heat treatment on the microstructure of the final titanium foam is apparent in FIGS. 10A and 10B, which shows scanning electron micrographs of fracture surfaces of titanium foam (with about 80 percent porosity) demonstrating a firm chemical bonding between titanium particles (arrows) after the two-step heat-treatment process. The additional heat treatment is important for achieving mechanically reliable titanium foam for use in load-bearing structural applications. FIGS. 10A and 10B show two scanning electron micrographs re at two different magnification levels.

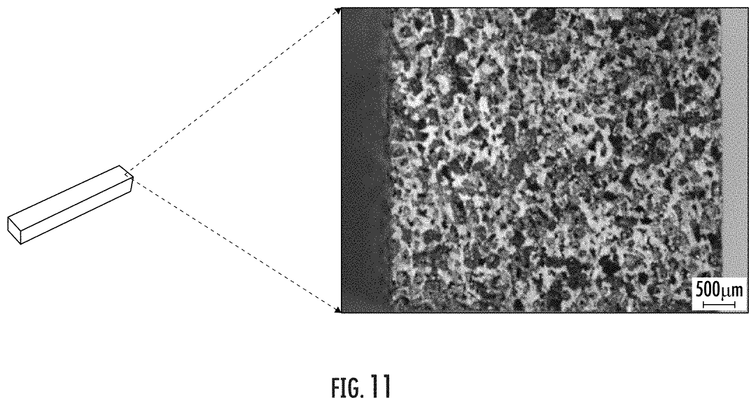

FIG. 11 shows a titanium-foam square bar (left) with smooth surfaces, exhibiting excellent machinability for structural component applications. A magnified view (right) is the representative microstructure of cut surface of the machined titanium foam. With the additional heat treatment, complex shapes and parts of titanium foam can be machined and used for structural applications.

While an embodiment example is described in some detail, those descriptions and the embodiment are not intended to limit the scope of the claimed invention. For example, the two-step space-holder technique described in FIG. 1 can also be applied to the manufacture of aluminum foam, copper foam or nickel foam.

This patent describes some examples of implementations with specific dimensions, measurements, temperatures, and values. These are not intended to be exhaustive or to limit the invention to the precise form described. The values, percentages, times, and temperatures are approximate values. These values can vary due to, for example, measurement or manufacturing variations or tolerances or other factors. For example, depending on the tightness of the manufacturing and measurement tolerances, the temperature and time values can vary plus or minus 5 percent, plus or minus 10 percent, plus or minus 15 percent, plus or minus 20 percent, or plus or minus 25 percent.

Further, the values are for a specific implementation, and other implementations can have different values, such as certain values made larger for a larger-scaled sized process or product, or smaller for a smaller-scaled product. A device, apparatus, or process may be made proportionally larger or smaller by adjusting relative measurements proportionally (e.g., maintaining the same or about the same ratio between different measurements). In various implementations, the values can be the same as the value given, about the same of the value given, at least or greater than the value given, or can be at most or less than the value given, or any combination of these.

### Embodiment 1

In an implementation, the manufacture of high-porosity open-porous titanium foam is described using space-holder process containing a two-step heat treatment for use in load-bearing applications. Some examples of load-bearing applications include relatively large size or three-dimensional battery or supercapacitor electrodes, or casing or structural part for information technology (IT) devices, replacements parts or panels for any metallic alloys used in construction and infrastructure (e.g., building structural members), device and component enclosures (e.g., television or display panel enclosures, computer and laptop enclosures, and others), ground or land vehicles (e.g., wagons, bicycles, scooters, motorcycles, cars, trucks, buses, and tanks), trains and trams, watercraft (e.g., ships, boats, and hovercrafts), aircraft (e.g., airplanes, helicopters), submarines and other submersibles, spacecraft (e.g., satellites, space stations), defense and military and related components and systems (e.g., missiles, rockets, guns, artillery, and ammunition), robots, machinery, and many other applications in order to reduce the weight of a load-bearing or structural member.

Titanium foam can be manufactured using a space-holder method with two-step heat treatment (e.g., sodium chloride powder to be removed later in water to create pores). In an implementation, a vacuum furnace with extremely high purity (greater than 10\hat{ }−4 torricelli) is used. The caret symbol (A) is used to denote that the number following the symbol is an exponent. In another implementation, a process uses a common furnace with an argon gas flow, which would be less expensive and simpler for high-volume manufacturing.

A process to manufacture the titanium foam has two heat treatments. A first heat treatment is before sodium chloride powder removal. A second heat treatment is after sodium chloride removal. The effect of the second heat treatment is to dramatically improve the mechanical properties of titanium foam for its use in load-bearing applications. It is apparent from scanning electronic microscope analysis (and images) that after the second heat treatment, the titanium powders in the titanium foam are chemically well bonded and enhance the durability of titanium foam.

In a specific implementation, a processing procedure includes:

1. In an implementation, sieves with specific pore size can then be used to control the desired pore size range to be achieved. For example, the sodium chloride powder is sieved through the two different sieves containing pore sizes of about 50 microns to about 100 microns to control the sodium chloride powder size ranging between about 50 microns and about 100 microns.

2. Blend titanium powder (about 1 micron to about 40 microns) with the sieved sodium chloride powder in a mixer for about 5 minutes to about 30 minutes. Here, the weight or volume ratio between the titanium and sodium chloride powders depends on the desired porosity target for the final titanium foam to be achieved.

3. Compact the mixture using an oil-hydraulic pressing machine under the pressure of about 10 to 200 megapascals for about 10 minutes to about 12 hours, simultaneously in a heated furnace under argon gas at between 200 degrees Celsius and 800 degrees Celsius.

In the pressing machine, in general, load or stress (load per area) is applied to the workpiece (e.g., mixture of titanium powder and sieved sodium chloride powder) and as a result, the workpiece experiences strain. In an implementation, the top column comes down to press the mold and the powder mixture against a bottom platen. As a result, the force is exerted equally from both sides (e.g., above and below).

4. Dissolve the spacer (e.g., NaCl) in the heat-treated compacts using water (about 20 degrees Celsius to about 100 degrees Celsius) with magnetic stirring or sonication.

5. Additionally heat treat (or sinter) the titanium foam at higher temperature under argon flow at about 700 degrees Celsius to about 1200 degrees Celsius for about 0.5 hour to about 10 hours (e.g., further sintering of the loosely connected titanium particles in titanium foam): Stronger microstructure is formed due to further chemical bonding between the loosely connected titanium powders. In this process flow, a first heating step is in the presser (step 3 above) and a second heating step is outside the presser.

6. The titanium foam is filled with crystal bond or polymer resin prior to grinding, cutting, and machining to form into a complex shaped component or part with smooth cut surfaces.

In an implementation, a method of forming a titanium foam includes: filtering an unfiltered sodium chloride space holder powder through a sieve to obtain filtered sodium chloride space holder powder having a particle size between about 30 microns and about 300 microns; mixing the filtered sodium chloride powder and titanium powder for about 5 minutes to about 30 minutes in an automatic mixer; heating the mixture of the filtered sodium chloride and titanium powders under argon gas in a furnace and pressing using a pneumatic presser for about 10 minutes to about 12 hours at between 200 degrees Celsius and 800 degrees Celsius under the pressure of about 10 to 200 megapascals to obtain a compacted sodium chloride and titanium composite (e.g., the heating and pressing can be performed simultaneously or at the same time); immersing the compacted sodium chloride and titanium composite in water for about 30 minutes to about 24 hours to dissolve away sodium chloride from the composite using sonication or stirring to obtain a titanium foam; and sintering the titanium foam at between about 700 degrees Celsius and about 1200 degrees Celsius under argon gas for about 0.5 hours to about 10 hours. The resulting titanium foam will have a porosity ranging from about 70 percent to about 90 percent, and a pore size distribution in any interval between about 30 microns and about 300 microns.

Further, the method can include filling the titanium foam with a crystal bond or polymer resin prior to grinding, cutting, and machining to form into a complex-shaped component or part with smooth cut surfaces. The method can include machining the titanium foam into a structural component using a water jet, wire cutting, or wire cutting.

A pore size distribution of the titanium foam can range between about 50 microns to about 100 microns. A pore size distribution of the titanium foam can range between about 100 microns to about 300 microns.

In various implementations, at least one of polymer, carbamide, saccharose crystals, urea, or calcium chloride powder is used as a space holder to replace the unfiltered sodium chloride space holder powder.

This description of the invention has been presented for the purposes of illustration and description. It is not intended to be exhaustive or to limit the invention to the precise form described, and many modifications and variations may be possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A titanium foam comprising:
a porosity ranging from about 70 percent to about 90 percent; and
a pore size distribution in any interval between about 30 microns and about 300 microns.

2. The titanium foam of claim 1 wherein the pore size distribution ranges between about 50 microns to about 100 microns.

3. The titanium foam of claim 1 wherein the pore size distribution ranges between about 100 microns to about 300 microns.

4. A structural component made from a titanium foam of claim 1, wherein the titanium foam is ground or machined using a water-jet method.

5. A structural component made from a titanium foam of claim 1, wherein the titanium foam is ground or machined using a wire-cutting method.

6. A structural component made from a titanium foam of claim 1, wherein the titanium foam is ground or machined using a saw cutting method.

7. The titanium foam of claim 1 wherein a manufacturing process to form the porous titanium foam comprises a sodium-chloride-space-holder method comprising:
the sodium chloride space holder powder is sieved to achieve an appropriate range of size, between about 30 microns and about 300 microns by applying a sieving process;
the sieved sodium chloride and titanium powders are mixed for about 5 minutes to about 30 minutes in an automatic mixer;
the mixture of the sieved sodium chloride and titanium powders is heated under argon gas in a furnace and pressed using a pneumatic presser for about 10 minutes to about 12 hours at between about 200 degrees Celsius and about 800 degrees Celsius under the pressure of about 10 megapascals to about 200 megapascals, wherein the mixture is heated and pressed at the same time;
the compacted sodium chloride and titanium composite is immersed in water for about 30 minutes to about 24 hours to dissolve away sodium chloride from the titanium foam using sonication or stirring;
an additional high-temperature sintering at between about 700 degrees Celsius and about 1200 degrees Celsius is conducted under argon gas for about 0.5 hours to about 10 hours; and
the titanium foam is filled with a crystal bond or polymer resin prior to grinding, cutting, and machining to form into a complex shaped component or part with smooth cut surfaces.

8. The titanium foam of claim 1 wherein at least one of polymer, carbamide (CO(NH₂)₂, saccharose crystals, urea, or calcium chloride powder is used as a space holder to replace sodium chloride powder.

9. A method of forming a titanium foam comprising:
filtering an unfiltered sodium chloride space holder powder through a sieve to obtain filtered sodium chloride space holder powder having a particle size between about 30 microns and about 300 microns;
mixing the filtered sodium chloride powder and titanium powder for about 5 minutes to about 30 minutes in an automatic mixer;
heating the mixture of the filtered sodium chloride and titanium powders under argon gas in a furnace and pressing using a pneumatic presser for about 10 minutes to about 12 hours at between 200 degrees Celsius and 800 degrees Celsius under the pressure of about 10 to 200 megapascals to obtain a compacted sodium chloride and titanium composite, wherein the heating and pressing occur at the same time;
immersing the compacted sodium chloride and titanium composite in water for about 30 minutes to about 24 hours to dissolve away sodium chloride from the composite using sonication or stirring to obtain a titanium foam; and
sintering the titanium foam at between about 700 degrees Celsius and about 1200 degrees Celsius under argon gas for about 0.5 hours to about 10 hours,
wherein the titanium foam comprises a porosity ranging from about 70 percent to about 90 percent, and a pore size distribution in any interval between about 30 microns and about 300 microns.

10. The method of claim 9 comprising:
filling the titanium foam with a crystal bond prior to grinding, cutting, and machining to form into a complex-shaped component or part with smooth cut surfaces.

11. The method of claim 9 comprising:
filling the titanium foam with a polymer resin prior to grinding, cutting, and machining to form into a complex-shaped component or part with smooth cut surfaces.

12. The method of claim 9 wherein the pore size distribution of the titanium foam ranges between about 50 microns to about 100 microns.

13. The method of claim 9 wherein the pore size distribution of the titanium foam ranges between about 100 microns to about 300 microns.

14. The method of claim 9 comprising:
machining the titanium foam into a structural component using a water jet.

15. The method of claim 9 comprising:
machining the titanium foam into a structural component using wire cutting.

16. The method of claim 9 comprising:
machining the titanium foam into a structural component using saw cutting.

17. The method of claim 9 wherein at least one of polymer, carbamide, saccharose crystals, urea, or calcium chloride powder is used as a space holder to replace the unfiltered sodium chloride space holder powder.
